(19) United States
(12) Patent Application Publication
(10) Pub. No.: US 2017/0003838 A1
(43) Pub. Date: Jan. 5, 2017

(54) VIEWING SYSTEM COMPRISING MEANS FOR SELECTING, SHARING AND DISPLAYING GRAPHICAL OBJECTS IN VARIOUS VIEWING MODES AND ASSOCIATED METHOD

(71) Applicant: THALES, Courbevoie (FR)

(72) Inventors: Patrick CAZAUX, Le Pian Medoc (FR); Laurent RIVAILLON, Gujan-Mestras (FR); Eric LEMOINE, Portets (FR)

(21) Appl. No.: 15/199,891

(22) Filed: Jun. 30, 2016

(30) Foreign Application Priority Data
Jul. 2, 2015 (FR) 1501402

(51) Int. Cl. G06F 3/0482; B64D 43/00; G06F 3/0481

(52) U.S. Cl. CPC G06F 3/0482; G06F 3/04815; G06F 3/0481; B64D 43/00

(57) ABSTRACT

The general field of the invention is that of aircraft cockpit viewing systems including a piece of human-machine interfacing equipment, a piece of data processing equipment and a viewing device. The piece of data processing equipment comprises a database including a plurality of objects and means for computing various displaying windows, each object having a plurality of forms of graphical representation in said windows. The viewing device is arranged to display the displaying windows. The piece of human-machine interfacing equipment includes means for selecting a state of graphical representation of an object in one of the windows. The states of graphical representation of the objects include a “selected” state. When the selection of a state of graphical representation of an object is effective, the computing means of the piece of processing equipment switch all of the various graphical representations of said object in the various windows to this “selected” state.

The field of the invention is that of aircraft cockpit viewing systems. These systems comprise a plurality of windows for presenting information that are distributed between a plurality of viewing devices especially forming part of the instrument panel of the aircraft. These windows may be redundant when the crew includes a pilot and co-pilot.

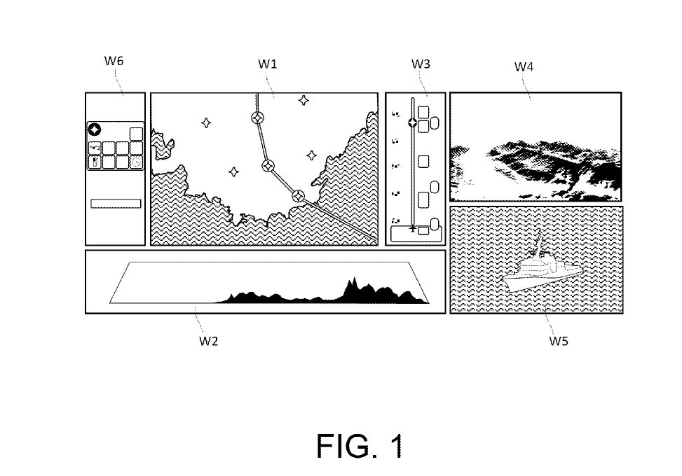

The presented information relates to the management of the mission of the aircraft and more particularly to piloting and navigation. By way of example, FIG. 1 shows various windows liable to be displayed on the viewing devices of the viewing system. The expression “viewing device” is understood not only to mean the screens of the instrument panel, but also systems for superposing information on the exterior, such as head-up displays, or helmet-mounted viewing systems worn by the pilot.

The organization of the windows in FIG. 1 is not representative of the actual arrangement in an aircraft cockpit, which may be different.

The first window W1 shows a horizontal view of the terrain being flown over. It may contain aeronautical information such as the flight plan of the aircraft with its various waypoints.

The second window W2 shows a vertical cross-sectional view of the terrain being flown over. Here again, this view may contain various pieces of aeronautical information.

The third window W3 shows a temporal view of the mission or flight plan. It generally includes a timeline in which the various phases of flight feature.

The fourth window W4 is a three-dimensional or 3D view of the terrain being flown over.

The fifth window W5 is a video view originating from on-board video cameras. This view may be an image of the exterior landscape, but also of the interior or exterior of the aircraft.

The sixth window W6 may be a window including information in the form of texts, numerical indications or of various symbols.

These various windows display a certain number of real or virtual objects specific to the aeronautical world. Mention will be made, by way of nonlimiting example, of:
objects required for navigation such as airports, navaids, flight plans, waypoints, etc.
objects specific to the terrain such as obstacles, geographical landmarks, etc.
moving objects such as other aircraft specific to air traffic, maritime traffic, etc.

A given object may therefore be shown in various ways in various views. Currently, viewing systems include only one designating system. Thus, the pilot can designate a particular object only in one single view. The patent U.S. Pat. No. 8,723,696 entitled “Location information generation system, device, and method” has a designating system allowing a particular position in a first representation of the terrain to be designated, the designation of this particular position causing the same position to be designated in a second representation of the terrain. This solution remains limited to cartographic representations.

The system according to the invention does not have this drawback. It allows, when an object is designated in one particular window, the same object to be designated in all the graphical windows that include it, whatever its representation. More precisely, one subject of the invention is an aircraft cockpit viewing system including at least one first piece of human-machine interfacing equipment, one first piece of data processing equipment and at least one first viewing device,

the first piece of data processing equipment comprising a first database including a plurality of objects and means for computing various first displaying windows including said objects, each object having a plurality of forms of presentation, each form of presentation having one or more states of graphical representation;

the first viewing device being arranged to display said first displaying windows; and

the first piece of human-machine interfacing equipment including first means for selecting a state of graphical representation of a form of presentation of one of said objects in one of said first windows;

characterized in that, the states of graphical representation of an object including what is called a “selected” state, when the selection of a state of graphical representation of a form of presentation of one of said objects is effective, the computing means of the first piece of processing equipment identify said object and switch all of the various graphical representations of said object in the various first windows to this what is called “selected” state.

Advantageously, the viewing system includes a second piece of human-machine interfacing equipment, a second piece of data processing equipment, a second viewing device and a data transferring network connected to the first piece of data processing equipment and the second piece of data processing equipment;

the second piece of data processing equipment comprising a second database including said plurality of objects and means for computing various second displaying windows including said objects, each object having a plurality of forms of presentation, each form of presentation having one or more states of graphical representation;

the second viewing device being arranged to display said second displaying windows;

the second piece of human-machine interfacing equipment including second means for selecting a state of graphical representation of a form of presentation of one of said objects in one of said second windows, and the states of graphical representation of an object including what is called a “selected” state; when the selection of a state of graphical representation of a form of presentation of one of said objects is effective, the computing means of the piece of processing equipment identify said object and switch all of the various graphical representations of said object in the various second windows to this what is called “selected” state and, by means of the data transferring network, switch all of the various graphical representations of said object in the various first windows to this what is called “selected” state.

Advantageously, when an object is identified, the computing means of the piece of processing equipment transmit to the various first windows object identification and parameterization data.

Advantageously, when the selected object is absent from one of said windows, the computing means of the piece of processing equipment create the object in said window in a what is called “selected” state.

Advantageously, the first or second displaying windows show either a horizontal view of a terrain, or a vertical cross-sectional view of said terrain, or a time scale including information on a mission of the aircraft, or a three-dimensional view of said terrain, or an image issued from an imaging sensor, or a window of textual information.

Advantageously, the plurality of objects are related to the field of navigation or to the terrain or to surrounding air or maritime traffic.

The invention also relates to a method for graphically representing an object in an aircraft cockpit viewing system including at least one first piece of human-machine interfacing equipment, one first piece of data processing equipment and at least one first viewing device,

the first piece of data processing equipment comprising a first database including a plurality of objects and means for computing various first displaying windows including said objects, each object having a plurality of forms of presentation, each form of presentation having one or more states of graphical representation;

the first viewing device being arranged to display said first displaying windows; and

the first piece of human-machine interfacing equipment including first means for selecting a state of graphical representation of a form of presentation of one of said objects in one of said first windows;

characterized in that the graphical representation method includes at least the following steps:

a step in which the first piece of human-machine interfacing equipment selects a state of graphical representation of a form of presentation of one of said objects in one of said first displaying windows;

a step in which the computing means of the first piece of processing equipment identifies said object; and

a step in which the computing means of the first piece of processing equipment switch all of the various graphical representations of said object in the various first windows to a what is called “selected” state of graphical representation.

Advantageously, the viewing system including a second piece of human-machine interfacing equipment, a second piece of data processing equipment, a second viewing device and a data transferring network connected to the first piece of data processing equipment and the second piece of data processing equipment;

the second piece of data processing equipment comprising a second database including said plurality of objects and means for computing various second displaying windows including said objects, each object having a plurality of forms of presentation, each form of presentation having one or more states of graphical representation;

the second viewing device being arranged to display said second displaying windows; and

the second piece of human-machine interfacing equipment including second means for selecting a state of graphical representation of a form of presentation of one of said objects in one of said second windows,

the graphical representation method includes at least the following steps:

a step in which the second piece of human-machine interfacing equipment selects a state of graphical representation of a form of presentation of one of said objects in one of said second displaying windows;

a step in which the computing means of the second piece of processing equipment identifies said object;

a step in which the computing means of the second piece of processing equipment switch all of the various graphical representations of said object in the various second windows to a what is called “selected” state of graphical representation;

a step in which the selected object is transferred by means of the data transferring network from the second piece of data processing equipment to the first piece of data processing equipment; and

a step in which the computing means of the first piece of data processing equipment switch all of the various graphical representations of said object in the various first windows to this what is called “selected” state of graphical representation.

The invention will be better understood and other advantages will become apparent on reading the following nonlimiting description and by virtue of the appended figures, in which:

FIG. 1 shows the various graphical windows of a cockpit viewing system according to the prior art;

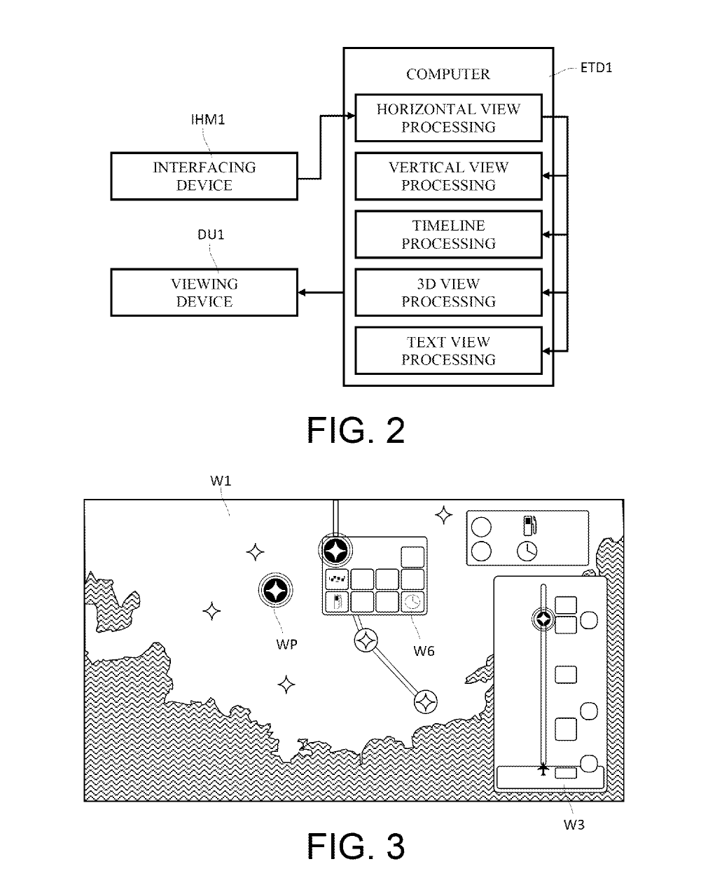

FIG. 2 shows a first block diagram of a cockpit viewing system according to the invention;

FIG. 3 shows various displaying windows including the representation of a selected object according to the invention; and

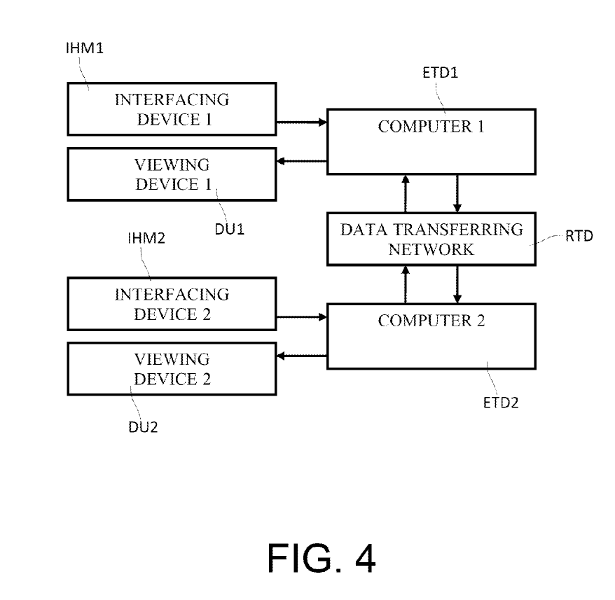

FIG. 4 shows a second block diagram of a cockpit viewing system according to the invention.

By way of first example, FIG. 2 shows a first block diagram of a cockpit viewing system according to the invention. It only includes one first piece of human-machine interfacing equipment IHM1, one first piece of data processing equipment ETD1 and at least one first viewing device DU1.

By way of example, the first piece of human-machine interfacing equipment may be an assembly comprising what is called a cursor control device (CCD), the equivalent of a computer “mouse”, a touch pad or touch panel placed on the viewing screen, a voice control or a gesture recognition control. This first piece of equipment includes first means for selecting a state of graphical representation of a form of presentation of said objects in one of said first windows. This selection may be obtained, for example, by means of a “click” on the control button of a mouse or by a touch designation on a touch panel.

The first piece of data processing equipment is an electronic computer. The core of the computer may be a processor, a system on chip (SOC) or even a field-programmable gate array (FPGA). The computer comprises a first database including a plurality of objects and components for computing various first displaying windows including said objects, each object having a plurality of forms of presentation, each form of presentation having one or more states of graphical representation.

The first viewing device arranged to display the first displaying windows may be an instrument panel viewing device i.e. a “head down” device, or a “head up” device displaying information in superposition on the exterior landscape, a piece of viewing equipment worn on the head of the user or mounted on a helmet, a “tablet”, etc. All these devices are known to those skilled in the art.

As was mentioned above, the displaying windows may be of various types. By way of nonlimiting example, the windows may correspond to:
a horizontal view of the terrain being flown over;
a view in a vertical cross-sectional plane of said terrain;
what is called a “timeline” view including information on the flight plan of the aircraft or on its mission;
a perspective or three-dimensional view of the terrain; this view may correspond to the landscape actually seen by the pilot or represent a particular zone of the mission to come such as, for example, the next touchdown point;
a window of textual information relating to the flight or airborne navigation;
a video image.

The sizes of the windows do not necessarily correspond to the sizes of the viewing screens. Thus, a plurality of windows may be shown on a single screen or one window may extend over a plurality of screens.

As was mentioned above, the displayable or displayed objects are of various natures. Mention will be made, by way of nonlimiting example, of:
objects required for navigation such as airports, navaids, flight plans, waypoints, etc.
objects specific to the terrain such as obstacles, geographical landmarks, etc.
moving objects such as other aircraft specific to air traffic, or the objects of maritime or road traffic.

Each object has specific graphical states each corresponding to one particular functional state. By way of example, mention will be made of the following states: active, selected, authorized, in distress, etc. The graphical representations may be differentiated using different colours or different shapes or by way of flashing lights or particular markings. In the system according to the invention, each object includes an additional dedicated graphical state called the “external highlight” state that means that the object has been designated by the first piece of human-machine interfacing equipment.

When an object is selected in one of the windows, the computer emits an event called “event external object selection” accompanied by the identifier of the selected object. When another displaying window receives this event, if this window includes the same object, then the object passes to the “external highlight” graphical state. In the same way, when an object is deselected in a particular window, it passes to this deselected state in all the windows that contain it.

For example, in FIG. 2, an object is selected in the window corresponding to the horizontal view. The selection is represented by a crooked arrow in this FIG. 2. The selection information is then transmitted to all the other windows then to the viewing device.

By way of example of the operation of the viewing system according to the invention, FIG. 3 shows three graphical windows W1, W3 and W6. These three windows are displayed on the same viewing screen. The window W1 shows a horizontal view of the terrain being flown over, the window W3 shows a timeline and the window W6 is a textual window. The user has selected a waypoint WP in the graphical window W1. The selection is represented in FIG. 3 by a concentric double circle. The computer has then switched the same waypoint in the windows W3 and W6, in which it is also shown in selected mode.

Of course, as illustrated in FIG. 4, the invention may be implemented in a viewing system including at least one second piece of human-machine interfacing equipment IHM2, one second piece of data processing equipment ETD2 and at least one second viewing device DU2. In this case, it is advantageous for an object selected in the first set of pieces of equipment to also be selected in the second set of pieces of equipment. To perform this function, it is necessary for the two pieces of data processing equipment to be connected by a piece of equipment or a data transferring network RTD. This network may conventionally be an ARINC 429 or AFDX Ethernet avionics network, the acronym “AFDX” standing for “Avionics Full DupleX” or a CAN bus, the acronym “CAN” standing for “Controller Area Network”. The network may also be a mass-market network such as an Ethernet network or a Wi-Fi wireless network.

It is thus possible to extend the invention to viewing systems including a plurality of pieces of human-machine interfacing equipment, a plurality of pieces of data processing equipment and a plurality of viewing devices.

When an object is selected, it is possible to make it appear in viewing devices that are inaccessible to the pieces of human-machine interfacing equipment such as are, by way of example, head-up viewing devices.

It is also possible, when an object is selected, to create it from scratch in a window in which it does not appear. In this case, when an object is selected in a first window, the latter:
sends the “event external object selection” event accompanied by the identifier of the selected object to the other windows of the viewing system; and
sends the “remote selection” event accompanied by the identifier of the object and its characteristics which are, for example, its name, its position, its altitude and the time of selection, to the remote pieces of HMI equipment.

When a window receives an “event external object selection” event then it displays the object in an “external highlight” state.

When a window receives a “remote selection” event, then:
if the object is known and already present, then the object is displayed in an “external highlight” state;
if the object is unknown and not present, then the object is created by virtue of the characteristics of the object, transferred and then displayed in this “external highlight” state.

The invention also applies to the deselection of displayed objects. When a selected object is deselected in a window, the associated component:
sends the “event external object deselection” event accompanied by the identifier of the selected object to the local piece of equipment; and
sends the “remote deselection” event accompanied by the identifier of the object and its characteristics to the other pieces of equipment. When a window receives an “event external object deselection” event then the object displayed in the “external highlight” state is displayed in a normal state.

When a piece of equipment receives a “remote deselection” event, then:
if the object displayed in the “external highlight” state is known and already present, then the window displays it in a normal state;
if the object displayed in the “external highlight” state was created specifically, then the window removes it and no longer displays it.

Thus, the user obtains, simply, an overview of a selected object and its characteristics on every display of his viewing system.

1. An aircraft cockpit viewing system comprising at least one first piece of human-machine interfacing equipment, one first piece of data processing equipment and at least one first viewing device,
the first piece of data processing equipment comprising a first database including a plurality of objects and means for computing various first displaying windows including said objects, each object having a plurality of forms of presentation, each form of presentation having one or more states of graphical representation;
the first viewing device being arranged to display said first displaying windows; and
the first piece of human-machine interfacing equipment including first means for selecting a state of graphical representation of a form of presentation of one of said objects in one of said first windows;
wherein the states of graphical representation of an object including what is called a “selected” state, when the selection of a state of graphical representation of a form of presentation of one of said objects is effective, the computing means of the first piece of processing equipment identify said object and switch all of the various graphical representations of said object in the various first windows to this what is called “selected” state.

2. The aircraft cockpit viewing system as claimed in claim 1, wherein the viewing system comprises a second piece of human-machine interfacing equipment, a second piece of data processing equipment, a second viewing device and a data transferring network connected to the first piece of data processing equipment and the second piece of data processing equipment;
the second piece of data processing equipment comprising a second database including said plurality of objects and means for computing various second displaying windows including said objects, each object having a plurality of forms of presentation, each form of presentation having one or more states of graphical representation;
the second viewing device being arranged to display said second displaying windows;
the second piece of human-machine interfacing equipment including second means for selecting a state of graphical representation of a form of presentation of one of said objects in one of said second windows, and the states of graphical representation of an object including what is called a “selected” state; when the selection of a state of graphical representation of a form of presentation of one of said objects is effective, the computing means of the piece of processing equipment identify said object and switch all of the various graphical representations of said object in the various second windows to this what is called “selected” state and, by means of the data transferring network, switch all of the various graphical representations of said object in the various first windows to this what is called “selected” state.

3. The aircraft cockpit viewing system as claimed in claim 1, wherein when an object is identified, the computing means of the piece of processing equipment transmit to the various first windows object identification and parameterization data.

4. The aircraft cockpit viewing system as claimed in claim 3, wherein when the selected object is absent from one of said windows, the computing means of the piece of processing equipment create the object in said window in a what is called “selected” state.

5. The aircraft cockpit viewing system as claimed in claim 1, wherein the first or second displaying windows show either a horizontal view of a terrain, or a vertical cross-sectional view of said terrain, or a time scale including information on a mission of the aircraft, or a three-dimensional view of said terrain, or an image issued from an imaging sensor, or a window of textual information.

6. The aircraft cockpit viewing system as claimed in claim 1, wherein the plurality of objects are related to the field of navigation or to the terrain or to air traffic or to maritime traffic.

7. A method for graphically representing an object in an aircraft cockpit viewing system comprising at least one first piece of human-machine interfacing equipment, one first piece of data processing equipment and at least one first viewing device,
the first piece of data processing equipment comprising a first database including a plurality of objects and means for computing various first displaying windows including said objects, each object having a plurality of forms of presentation, each form of presentation having one or more states of graphical representation;
the first viewing device being arranged to display said first displaying windows; and
the first piece of human-machine interfacing equipment including first means for selecting a state of graphical representation of a form of presentation of one of said objects in one of said first windows;
wherein the graphical representation method includes at least the following:
an operation in which the first piece of human-machine interfacing equipment selects a state of graphical representation of a form of presentation of one of said objects in one of said first displaying windows;
an operation in which the computing means of the first piece of processing equipment identifies said object; and
an operation in which the computing means of the first piece of processing equipment switch all of the various graphical representations of said object in the various first windows to a what is called “selected” state of graphical representation.

8. The method for graphically representing an object in a aircraft cockpit viewing system as claimed in claim 7, wherein the viewing system comprises a second piece of human-machine interfacing equipment, a second piece of data processing equipment, a second viewing device and a data transferring network connected to the first piece of data processing equipment and the second piece of data processing equipment;
the second piece of data processing equipment comprising a second database including said plurality of objects and means for computing various second displaying windows including said objects, each object having a plurality of forms of presentation, each form of presentation having one or more states of graphical representation;
the second viewing device being arranged to display said second displaying windows; and
the second piece of human-machine interfacing equipment including second means for selecting a state of graphical representation of a form of presentation of one of said objects in one of said second windows,
the graphical representation method includes at least the following:
an operation in which the second piece of human-machine interfacing equipment selects a state of graphical representation of a form of presentation of one of said objects in one of said second displaying windows;
an operation in which the computing means of the second piece of processing equipment identifies said object;
an operation in which the computing means of the second piece of processing equipment switch all of the various graphical representations of said object in the various second windows to a what is called “selected” state of graphical representation;
an operation in which the selected object is transferred by means of the data transferring network from the second piece of data processing equipment to the first piece of data processing equipment; and
an operation in which the computing means of the first piece of data processing equipment switch all of the various graphical representations of said object in the various first windows to this what is called “selected” state of graphical representation.
